(19) United States
(12) Patent Application Publication
(10) Pub. No.: US 2025/0374023 A1
(43) Pub. Date: Dec. 4, 2025

(54) MAP-LESS PROXIMITY

(71) Applicant: QUALCOMM Incorporated, San Diego, CA (US)

(72) Inventors: Abhishek PRASAD, Barrington (GB); Benjamin TARLOW, Cambridge (GB); Archit YADAV, Cambridge (GB)

(21) Appl. No.: 18/816,352

(22) Filed: Aug. 27, 2024

Related U.S. Application Data
(60) Provisional application No. 63/653,140, filed on May 29, 2024.

(51) Int. Cl. H04W 8/00

(52) U.S. Cl. CPC H04W 8/005

(57) ABSTRACT

In some implementations, a method of enabling map-less proximity detection may include determining an initial set of proximity relationships between at least a subset of a plurality of transceivers, each transceiver located at a different respective position within a volume or venue. The proximity relationships may be indicative of a spatial relationship between at least a portion of the plurality of transceivers. The method may include obtaining a plurality of measurements of radio frequency (RF) signals transmitted by the plurality of transceivers, the measurements performed by a first mobile device at different locations in the volume or venue. The method may include determining a modified set of proximity relationships having the initial set of proximity relationships, modified based on information from the plurality of measurements.

### RELATED APPLICATIONS

This application claims the benefit of U.S. Provisional Application No. 63/653,140, filed May 29, 2024, entitled “MAP-LESS PROXIMITY,” which is assigned to the assignee hereof, and incorporated herein in its entirety by reference.

### FIELD OF DISCLOSURE

The present disclosure relates generally to the field of wireless positioning and, more specifically, to proximity detection in an indoor venue.

### BACKGROUND

Positioning systems in a retail environment can offer a large number of benefits to retailers. When paired with tabulated store data (TSD) that indicate the location (e.g., row and aisle) of an item, a positioning system can determine where a store employee is using radio frequency (RF) signals transmitted and/or received by a mobile device carried by the employee and alert the employee when the employee gets within a threshold proximity of the item. To provide this functionality, positioning systems traditionally rely on an updated map (or floor plan) of the store.

### BRIEF SUMMARY

Embodiments described herein are directed toward proximity systems that use a map-less approach to determining proximity. That is, rather than relying on a map and using location, embodiments can allow for detection of proximity of a mobile device to a point of interest (POI) based on proximity relationships between transceivers corresponding to the POI and the one or more transceivers for which RF signals are measuring by the mobile device (e.g., above a threshold power).

In one general aspect, an example method may include determining an initial set of proximity relationships between at least a subset of the plurality of transceivers, where: each transceiver of the plurality of transceivers is located at a different respective position within a volume or venue, and the proximity relationships are indicative of a spatial relationship between at least a portion of the plurality of transceivers. The method may also include obtaining a plurality of measurements of radio frequency (RF) signals transmitted by the plurality of transceivers, where the measurements are performed by a first mobile device at different locations in the volume or venue in which the plurality of transceivers are located. The method may furthermore include determining a modified set of proximity relationships between the at least the subset of the plurality of transceivers, the modified set of proximity relationships having the initial set of proximity relationships, modified based on information from the plurality of measurements.

An example computer system, according to this description, may include at least one communication interface, at least one memory, and at least one processor communicatively coupled with the at least one communication interface and at least one memory. The at least one processor may be configured to: determine an initial set of proximity relationships between at least a subset of the plurality of transceivers, where: each transceiver of the plurality of transceivers is located at a different respective position within a volume or venue, and the proximity relationships are indicative of a spatial relationship between at least a portion of the plurality of transceivers. The at least one processor further may be configured to obtain, via the at least one communication interface, a plurality of measurements of radio frequency (RF) signals transmitted by the plurality of transceivers, where the measurements are performed by a first mobile device at different locations in the volume or venue in which the plurality of transceivers are located. The at least one processor further may be configured to determine a modified set of proximity relationships between the at least the subset of the plurality of transceivers, the modified set of proximity relationships having the initial set of proximity relationships, modified based on information from the plurality of measurements.

An example device, according to this description, may include means for determining an initial set of proximity relationships between at least a subset of the plurality of transceivers, where each transceiver of the plurality of transceivers is located at a different respective position within a volume or venue, and the proximity relationships are indicative of a spatial relationship between at least a portion of the plurality of transceivers. The device may also include means for obtaining a plurality of measurements of radio frequency (RF) signals transmitted by the plurality of transceivers, where the measurements are performed by a first mobile device at different locations in the volume or venue in which the plurality of transceivers are located. The device may furthermore include means for determining a modified set of proximity relationships between the at least the subset of the plurality of transceivers, the modified set of proximity relationships having the initial set of proximity relationships, modified based on information from the plurality of measurements.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

FIG. 1 is an illustration of an example store aisle, according to an embodiment.

FIG. 2 is a graph of a generic floor plan of a retail venue, according to an embodiment.

FIG. 3 is an illustration of an example proximity graph, according to an embodiment.

FIG. 4 is a proximity graph made from tabulated store data (TSD), according to an example.

FIG. 5 is an illustration of a portion of a retail venue, according to an embodiment.

FIG. 6 is a diagram of an algorithm that may be used to help determine aisles that share a walkway based on survey measurements, according to an embodiment.

FIG. 7 is a graph illustrating actual proximity measurements using the techniques described herein, in an experimental setup.

FIG. 8 is a flow diagram of a method of enabling proximity detection among a plurality of transceivers, according to an embodiment.

FIG. 9 is a block diagram of an embodiment of a mobile device.

FIG. 10 is a block diagram of an embodiment of a computer system.

Like reference symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3 etc. or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c).

### DETAILED DESCRIPTION

The following description is directed to certain implementations for the purposes of describing innovative aspects of various embodiments. However, a person having ordinary skill in the art will readily recognize that the teachings herein can be applied in a multitude of different ways. The described implementations may be implemented in any device, system, or network that is capable of transmitting and receiving radio frequency (RF) signals according to any communication standard, such as any of the Institute of Electrical and Electronics Engineers (IEEE) 802.15.4 standards for ultra-wideband (UWB), IEEE 802.11 standards (including those identified as Wi-Fi® technologies), the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Rate Packet Data (HRPD), High Speed Packet Access (HSPA), High Speed Downlink Packet Access (HSDPA), High Speed Uplink Packet Access (HSUPA), Evolved High Speed Packet Access (HSPA+), Long Term Evolution (LTE), Advanced Mobile Phone System (AMPS), or other known signals that are used to communicate within a wireless, cellular or internet of things (IoT) network, such as a system utilizing 3G, 4G, 5G, 6G, or further implementations thereof, technology.

As used herein, an “RF signal” comprises an electromagnetic wave that transports information through the space between a transmitter (or transmitting device) and a receiver (or receiving device). As used herein, a transmitter may transmit a single “RF signal” or multiple “RF signals” to a receiver. However, the receiver may receive multiple “RF signals” corresponding to each transmitted RF signal due to the propagation characteristics of RF signals through multiple channels or paths.

Additionally, as used herein, the term “transceiver” refers to an electronic device or component capable of transmitting and receiving RF signals. It can be noted, however, that the functions of receiving and transmitting may be performed using separate components or even separate co-located devices. Further, the term “transceiver” may be used to describe several embodiments herein. However, alternative embodiments may simply use a receiver or transmitter rather than a transceiver, depending on desired functionality. For example, some of the functionality performed by “transceivers” described herein may be performed by beaconing devices that may or may not be capable of receiving RF signals.

Further, unless otherwise specified, the term “positioning” as used herein may include absolute location determination, relative location determination, ranging, or a combination thereof. Such positioning may include and/or be based on timing, angular, phase, or power measurements, or a combination thereof (which may include RF sensing measurements) for the purpose of location or sensing services.

It can be noted that, although example embodiments described herein are often in reference to a “retail venue,” embodiments are not so limited. Moreover, the term “venue,” as used herein, may broadly refer to a physical location or space designed or adapted to accommodate or facilitate a particular activity, event, or function, which may be permanent (e.g., a retail store) or temporary (e.g., a concert event), and may encompass indoor and/or outdoor settings. Example venues include buildings, structures, grounds, parks, fields, arenas, stadiums, theaters, auditoriums, convention centers, exhibition halls, gardens, plazas, courtyards, or any other designated areas that serve as a host or setting for a particular purpose, or any combination thereof.

As previously noted, positioning systems in a retail environment can provide useful information to employees regarding the location of store items, such as a proximity alert when a store employee is within a threshold distance of an item or location of interest (more broadly referred to herein as a point of interest (POI)). However, this functionality typically relies on the proximity system having an updated map (floor plan) of the store. This can be problematic, however, because up-to-date floor plans often do not exist. This is because they can take a long time to create after the configuration or reconfiguration of a retail space. The absence of an up-to-date floor plan could lead to increased downtime and/or other inefficiencies caused by the inability of a retail positioning system to provide accurate store-specific location information. Due to this difficulty in getting up-to-date floor plans, and because each retail venue can be unique (even different venues of the same retailer), floor plan-based positioning systems can be difficult to scale.

Embodiments disclosed herein address these and other issues by providing a solution for proximity detection, a very common use case of positioning systems, without reliance on a floor plan. As discussed herein, aspects may include determining an initial set of proximity relationships (e.g., a proximity graph showing neighbor relationships) of existing transceivers dispersed throughout a retail venue (e.g., located on each rail and/or electronic store label) using measurements made by the transceivers and/or tabulated store data (TSD) indicative of where transceivers are located in relation to each other. The locations of transceivers may not be known. According to some aspects, a mobile device may then perform a basic device-based survey by performing measurements at different locations throughout the venue to create a modified set of proximity relationships in which the initial set of proximity relationships is modified based on the measurements to include, for example, transceiver relationships indicative of shared walkways between aisles on which transceivers are located. The modified set of proximity relationships may then be used for subsequent proximity determination, e.g., of a mobile device used by a store employee or even customer to a point of interest (POI) associated with a particular transceiver. It can be noted that although embodiments provided herein describe a retail environment or venue, embodiments are not so limited. Embodiments may be used in other environments and applications in which proximity detection for transceivers located throughout the space or volume may be desirable, such as a warehouse, factory floor, or other commercial or industrial environments.

Particular aspects of the subject matter described in this disclosure can be implemented to realize one or more of the following potential advantages. In some examples, by creating and using a proximity graph, the described techniques can be used to enable proximity detection without foreknowledge of transceiver locations or an updated floor plan. Moreover, embodiments can enable such proximity detection with higher accuracy (e.g., fewer false negatives) than proximity determination techniques that use simple detection of a single transceiver of interest. These and other advantages will be apparent to a person of ordinary skill in the art in view of the description of the various embodiments provided in this disclosure. Embodiments are provided after a brief description of relevant background information.

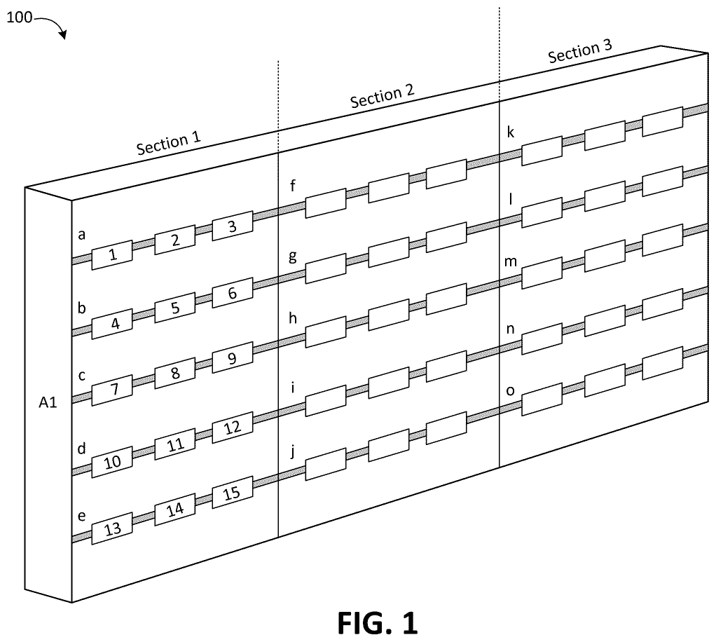

FIG. 1 is an illustration of an example store aisle 100, according to an embodiment, provided here to establish basic terminology used throughout this disclosure. In this example, aisle “A1” includes three sections (which also may be referred to as “units” or “modular”), where each section is divided into different shelves, each having a respective “rail” affixed or coupled thereto (e.g., fastened to the front of the shelf). In FIG. 1, rails are labeled alphabetically: section 1 has rails a-e, section 2 has rails f-j, and section 3 has rails k-o. Further, a set of electronic store labels (ESLs, also known as “digital store labels” (DSLs)) are clipped into place or otherwise coupled to each rail. Each ESL includes a display, which is typically a low-power display, such as an electronic paper or electronic ink (e-ink) display. ESL can display information regarding items on the shelves to which the ESL is coupled, including name, price, description, stock keeping unit (SKU), and/or the like. (In FIG. 1, ESLs in section 1 are labeled 1-15. To avoid clutter, ESLs are not labeled in sections 2 or 3.)

The usage of transceivers in an aisle such as aisle 100 may vary, depending on desired functionality. According to some embodiments, each rail may have a transceiver capable of transmitting and receiving information (e.g., via BLUETOOTH or BLUETOOTH LOW ENERGY (BLE)). In such embodiments, these rail transceivers may receive updated item information (e.g., from a store computer) for one or more ESLs located on the rail and configure the one or more ESLs (e.g., using over-the-air (OTA) updates) to indicate the updated information. Additionally, or alternatively, each ESL may have its own transceiver capable of transmitting and receiving RF signals with a corresponding rail transceiver and/or another wireless transceiver. Some embodiments may not use rail transceivers, or may not use rails at all, in which case ESLs may have transceivers that perform the functionality described in the embodiments below for enabling proximity detection. Regardless of how transceivers are set up (e.g., one transceiver per rail or one transceiver per ESL), embodiments may utilize transceivers as described below to transmit and receive RF signals to generate a proximity graph.

It can be noted that the size, shape, and quantity of the various components illustrated in FIG. 1 can vary. An aisle may have a different number of sections than illustrated, sections may have a different number of shelves/rails, and/or rails may have different numbers of ESLs. Further, shelves/rails and/or ESLs may be movable to accommodate items of different sizes. Aisles with large items may have relatively few rails and/or ESLs (and, therefore, relatively few transceivers), whereas aisles with small items may have relatively many rails and/or ESLs (and, therefore, relatively many transceivers).

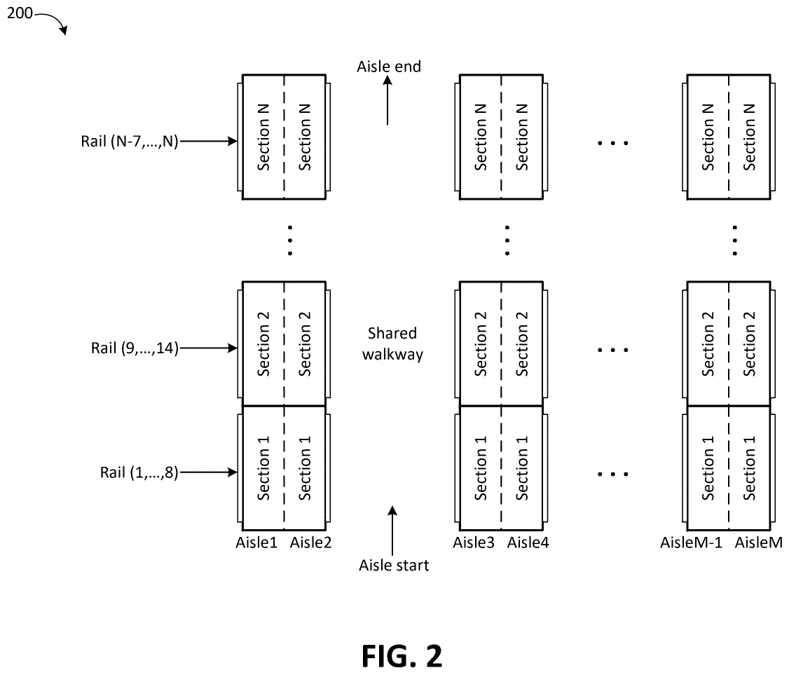

FIG. 2 is a graph of a generic floor plan 200, provided to help illustrate the relationship between different aisles. Here, aisles 1-M are illustrated, where each file has N sections, and each section has 8 rails. (Again, the number of rails, aisles, and sections may vary, depending on the desired floor plan.) As illustrated, aisles may be “back-to-back” with other aisles: aisles 1 and 2 are back-to-back, and so are aisles 3 and 4. Aisles 2 and 3, however, share a walkway. As described in more detail below, it can be helpful to establish which aisles share a walkway for purposes of enabling accurate proximity detection. Further, although not illustrated in FIG. 2, aisles may be located in different “zones” of a retail venue.

As with other figures provided herein, FIG. 2 is provided as a nonlimiting example. Other floor plans may have other features. For example, some floor plans may have aisles that are not back-to-back with other aisles (e.g., aisles against a wall of the retail venue), aisles that shared walkways with more than one aisle (e.g., one long aisle that shares a walkway with two or more shorter aisles), or the like. Further, floor plans may have aisles that extend in different directions (e.g., not parallel), aisles that are not straight, and/or have other features that are not illustrated in FIG. 2. Embodiments for enabling proximity detection described herein may apply to a wide variety of floor plans that may include features not illustrated in FIG. 2.

As noted previously, retailers often do not have an up-to-date floor plan of a retail venue that provides location information for aisles in the manner depicted in FIG. 2. However, retailers will have up-to-date data on stock listing in a database called tabulated store data (TSD). This data provides the semantic location (e.g., aisle, section, rail, etc.) of every item in the store, along with other data such as item description, item type, barcode data, etc. As such, this data includes an association between ESLs and rails, as well as associating each rail to a semantic tuple (e.g., zone, aisle, section). Moreover, some TSD information may be sufficient to derive an order of rails along an aisle.

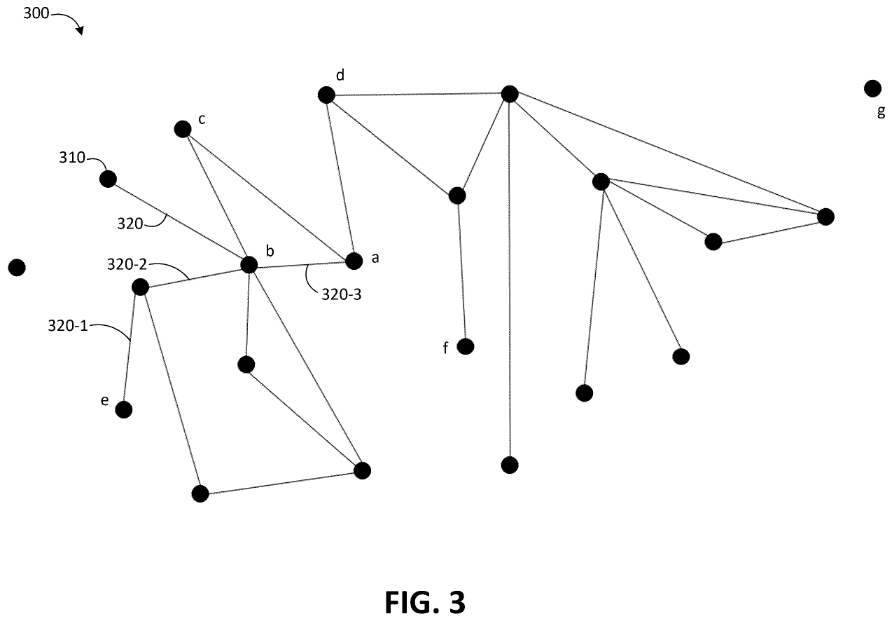

Proximity detection can enable retail employees to engage in various proximity-based actions when they are within a threshold distance of a POI. For example, an employee carrying an electronic mobile device with which proximity detection may be made may allow for functionality such as an LED located on a rail flashing when the employee (or mobile device) is within a threshold distance from the rail. This action can be to restock or replace a certain item and may be based on information in the TSD, for example. According to embodiments herein, “map-less” proximity detection in a retail (or other) environment may be enabled by creating a proximity graph that leverages the information and/or transceiver functionality discussed above. FIG. 3 shows an example of a proximity graph.

FIG. 3 is an illustration of an example proximity graph 300, according to an embodiment. Here, the proximity graph 300 shows a set of proximity relationships between a plurality of vertices (some of which are labeled a-f), represented as dots 310, and edges, represented as lines 320. Edges indicate neighboring vertices. Vertex a, for example, neighbors vertices b, c, and d. Vertex e, on the other hand, is at least three edges (lines 320-1, 320-2, and 320-3) away from vertex a. And thus, vertices a and e are not neighbors in this proximity graph 300. (The number of edges between two vertices, however, can be a measure of the proximity between the two vertices.) Additionally, vertex g has no known neighbors.

According to embodiments, measurement information and/or TSD information may be used to establish an initial proximity graph between different transceivers (e.g., associated with each rail and/or each ESL). That is, an initial proximity graph may represent transceivers as vertices and vertices of neighboring transceivers may have edges between them. As described in more detail below, creating a proximity graph of transceivers in this manner can help provide accurate proximity detection in an indoor space with a plurality of transceivers located throughout the space without the need for a floor plan or map. According to some embodiments, this may be done, for example, using one or two of the following techniques.

A first technique for creating an initial proximity graph between transceivers located at various locations within a retail venue may comprise using basic power measurements between transceivers, such as Received Signal Strength Indicator (RSSI) measurements. According to this method, transceivers may transmit RF signals and receive the transmitted RF signals from other transceivers. (For signal strength measurements using this first technique and other signal strength measurements described herein, each transceiver may transmit RF signals that include identity information of the transceiver, thereby enabling a receiving device to identify the originating transceiver that transmitted the RF signals.) Transceivers that are near each other will often have relatively high received power strength measurements from each other, whereas transceivers that are relatively distant from each other typically will have relatively low received power strength measurements. Signal strength measurements between two transceivers exceeding a threshold in one or both directions (e.g., an RSSI greater than −50 dBm) may result in an edge between the vertices corresponding to the two transceivers. According to some embodiments, measurements among transceivers can be coordinated (e.g., with a store computer) to allow for various transceivers to transmit and receive at different times to help maximize the likelihood that transceivers will receive signals transmitted by neighboring transceivers. Because signal strength can be impacted by fast fading, transceiver orientation, shielding, multipath, antenna position, etc., this technique may have some inaccuracies. For example, a strong signal strength measured by a first transceiver of an RF signal transmitted by a second transceiver can be indicative that the first and second transceivers are close together. However, a weak signal strength does not necessarily mean that the first and second transceivers are far apart. It may instead mean that there is something blocking the signal. Even so, this first technique can be helpful in making an initial proximity graph between transceivers. Moreover, in some embodiments, the first technique may be used in conjunction with the second technique, described below, to provide an initial proximity graph.

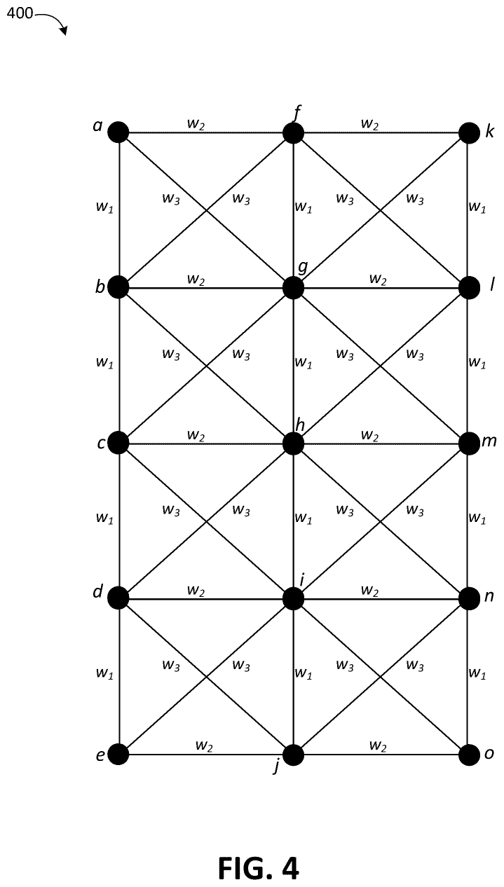

A second technique for creating the initial proximity graph comprises using TSD to determine neighboring transceivers (e.g., neighboring rails and/or neighboring ESLs). Because TSD includes information such as zone, aisle, section, and rail of each item, neighboring rails can be determined within a section, neighboring sections can be determined within an aisle, and so forth. In this technique, “neighboring” transceivers may be determined based not only on information found in the TSD but also knowledge of the relationship between zone, aisle, section, and rail. According to some embodiments, this relationship may be automatically determined based on the TSD, conventions used in the industry, previously received information regarding the types of files/modules/sections used, etc., or the like. Additionally, or alternatively, a computer creating the initial proximity graph from the TSD may prompt a user for input to provide and/or confirm this relationship. The resulting graph may look something like FIG. 4, for example.

FIG. 4 is a proximity graph 400 made from TSD, according to an example. Here, vertices are labeled a-o, where different columns of the graph may represent different shelves in a section, and each vertex may represent a transceiver associated with a rail. Thus, proximity graph 400 may represent a proximity graph determined from the store aisle 100 from FIG. 1: vertices a-e correspond to rails a-e of section 1, vertices f-j correspond to rails f-j of section 2, and vertices k-o correspond to rails k-o of section 3. Further, in proximity graph 400, edges are created between vertices corresponding to neighboring rails within a section as well as neighboring rails (e.g., on the same shelf) in adjacent sections. Further, edges may also be created between adjacent rails of adjacent sections (shown as diagonal edges in FIG. 4). Although graph 400 is made from TSD, it can be noted that, in some instances, it may be possible to create an initial proximity graph similar to the proximity graph 400 using signal strength measurements as described with respect to the first technique above.

Additionally, according to some embodiments, edges may be weighted with one or more weights. As shown in FIG. 1, vertices representing adjacent rails in the same section are connected with a first weight “w₁,” vertices representing neighboring rails (e.g., on the same shelf) in the adjacent sections are connected with a second weight “w₂,” and vertices representing adjacent rails in the adjacent sections (diagonal edges in FIG. 4) are connected with a third weight “w₃.” In this example, weights w₁-w₃ may decrease in value from w₁ to w₃, where a higher weight value represents closer proximity. These weights may be determined, for example, using knowledge of the physical layout of an aisle (e.g., FIG. 1) along with TSD (e.g., the second technique above) and/or measured signal strength (e.g., RSSI) information (the first technique above).

The process of determining an initial proximity graph for a set of transceivers, as described above, may be triggered by any of a variety of events, depending on desired functionality. For example, a computer may use one or both of the techniques above based on a schedule (e.g., daily, weekly, etc.) and/or based on a determination that a triggering event has occurred (e.g., a floor plan has been updated, one or more transceivers ESLs have moved, etc.). This determination may be based on user input and/or information received from one or more of the transceivers (e.g., a transceiver detecting or measuring RF signals from one or more new transceivers, a transceiver no longer detecting a previously-detected transceiver, etc.), which may be communicatively coupled with the computer.

With regard to the proximity graphs shown in FIGS. 3 and 4 described above, it can be noted that the creation of such graphs may simply represent the creation of data in a memory (e.g., database) of a computer representative of the information in these graphs. (As a person of ordinary skill in the art will appreciate, an actual visual graph may not be created.) The extent to which edges are created between vertices may be limited by the information obtained using the first and/or second technique described above (and/or other techniques) for creating the proximity graphs. As described in more detail below, additional information, such as the relationship between aisles (e.g., whether they share a walkway, are back to back, etc.) may be obtained and used to modify the initial proximity graph made using first and/or second techniques described above.

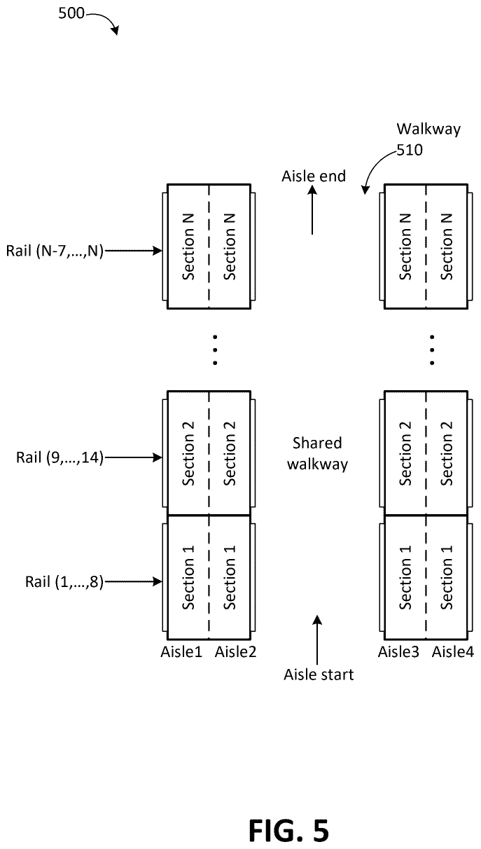

FIG. 5 is an illustration 500 of a portion of a retail venue, provided here to help illustrate how relationships between aisles can be determined. As noted previously and shown in illustration 500, adjacent aisles may be back-to-back or may share a walkway. Further, one long aisle may share a walkway with multiple shorter aisles. Thus, determining these types of relationships between aisles might not be straightforward from the TSD alone.

These types of relationships can be important for proximity detection. For example, it may be helpful for an employee walking down the walkway 510 between aisle 2 and aisle 3 to be alerted to any POIs along these aisles. However, because aisles 1 and aisles 4 are not accessible from the walkway 510, it may also be important to ignore POIs along these aisles. However, because aisles 1 and 4 are back-to-back with aisles 2 and 3, respectively, algorithms for creating a proximity graph based solely on proximity rather than journey time between vertices may not adequately capture these relationships. This could result in “false positives” in proximity detection where a store employee is alerted of POIs from aisles 1 and/or 4 when walking along walkway 510, even though the employee is not proximate to such POIs from a journey time standpoint.

According to some embodiments, information from a device-based survey may be used to modify the initial proximity graph to reflect relationships between aisles while also addressing the issue of false positives noted above. In such embodiments, a mobile device may be used to collect measurements (e.g., signal strength/RSSI measurements) of RF signals transmitted by the transceivers (e.g., of the rails and/or ESLs represented in the proximity graph) while moving through the retail venue. Such a survey may be made opportunistically, for example, while a store employee (or robot, cart, etc.) moves throughout the store on ordinary business. Additionally, or alternatively, a survey may be guided such that the store employee makes a deliberate path through the retail venue to help obtain an optimal set of RF measurements. A set of measurements may be made, for example, periodically (e.g., every second, every 5 seconds, every 10 seconds, etc.) by the mobile device. According to some embodiments, such measuring may be triggered by detected movement of the device (e.g., from accelerometers, inertial measurement units (IMUs), gyroscopes, etc. of the device). Measurements made by the device may be coordinated, for example, by an application run on the mobile device. Importantly, unlike surveys that may be done for positioning, a ground truth position of the mobile device conducting the survey does not need to be made. That is, for purposes of modifying the initial proximity graph to include relationships between transceivers in different aisles, the mobile device can perform the RF measurements without any determination of where the mobile device is located when the measurements are performed. This can provide for easier implementation. (That said, the position of the device corresponding to a location of the device when RF measurements are made can be determined, which can be used to inform modifications to the proximity graph, if desired.)

A survey that takes measurements in this manner can help determine which aisles are back-to-back and which share a common walkway. For many RF technologies (e.g., BLE), when a mobile device is located between two sets of shelves, signal strength measurements from transmitters located on shelving units immediately on either side of the walkway are higher than those located on back-to-back shelves, implicitly applying Line of Sight (LoS) constraints. Using the accumulation of these measurement sets made over a period of time, much of the noise and/or other problems previously noted (e.g., multipath, shielding, etc.) can be filtered out, and a spatial relationship between aisles can be deduced. These spatial relationships can then be used to modify the initial proximity graph described above to indicate relationships (e.g., edges) between transceivers on different aisles. Specifically, edges may be established between vertices that correspond with transceivers on aisles that share a walkway (e.g., aisles 2 and 3 in FIG. 5).

According to some embodiments, some TSD information, if available, also may be used to determine aisles that are back-to-back. For example, back-to-back aisles may share a separate section at the end of the aisle. In some cases, TSD information may indicate such shared sections, thereby indicating aisles that are back-to-back. If such information exists, it can be used to help modify the proximity diagram (e.g., by removing any edges that may have been drawn between transceivers of back-to-back aisles).

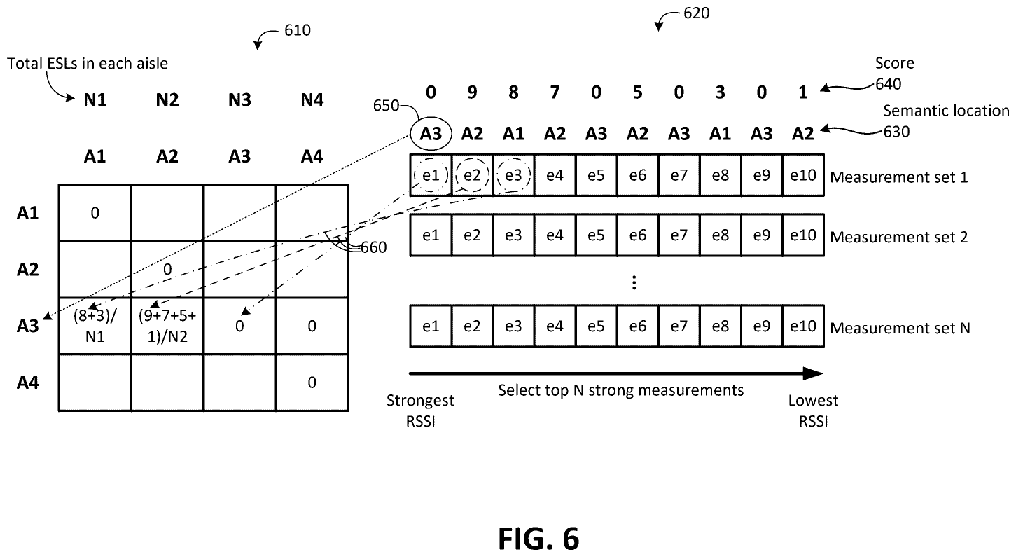

FIG. 6 is a diagram of an algorithm that may be used to help determine aisles that share a walkway based on survey measurements, according to an embodiment. As described above, survey measurements may be taken to determine relationships between aisles, and the initial proximity diagram can be modified to include such relationships. It can be noted, however, that this is only one such algorithm. Alternative embodiments may process survey measurements in a different way, depending on the desired functionality. Moreover, alternative embodiments may modify the algorithm provided in FIG. 6 in a variety of ways while preserving the ultimate goal of determining aisles that share walkways.

Generally put, the algorithm in FIG. 6 involves completing table 610 based on measurement sets 620 obtained from a survey conducted by mobile device, as previously described. It can be noted that, in practice, measurement sets may include more measurements than shown in FIG. 6. There may be, for example, 200 measurements in each set. Moreover, measurement sets may have a different number of measurements depending on how many transceivers are detected by the mobile device at any given moment. However, as noted in FIG. 6, the algorithm may use only some threshold number (N) of the strongest measurements of each measurement set. (In FIG. 6, the top 10 strongest RSSI measurements are shown, where measurement e1 represents the strongest measurement and e10 represents the weakest measurement of these top 10 strongest measurements of each measurement set.) The use of the top N strong measurements in this manner can help exclude weaker signals that may have a lower signal-to-noise (SNR) ratio and may, therefore, be less reliable. In some embodiments, N may represent a predetermined number or percentage. In some embodiments, N may represent the number of measurements that exceed a threshold power level.

To fill out the table 610, each measurement set (e.g., measurement set 1-N) may be analyzed as follows. First, the N strongest measurements may be identified, and a semantic location 630 can be determined for each measurement. This can be done, for example, by identifying the transceiver that originates the RF signal for which the measurement is made and then determining the ideal of the transceiver using TSD. In the example of FIG. 6, the top 10 measurements of measurements set 1 are attributed to transceivers in aisles A1, A2, and A3. The aisle corresponding to the strongest measurement dictates which row in table 610 will be modified based on a given measurement set. As illustrated by circle 650 in FIG. 6, aisle A3 corresponds to the strongest measurement, e1, of measurement set 1. And thus, the row in table 610 corresponding to A3 is modified by measurement set 1.

Each measurement and measurement set 1 is then given a score 640 that is used to modify the cells in row A3 of the table 610. In this example, scores ranging from 10 to 1 are respectively assigned to measurements e1 to e10. However, scores for the row being modified in table 610 (A3, in the case of measurement set 1) are set to zero. This is because the row being modified is meant to identify which one or more rows share a walkway with the aisle corresponding with the row. (Because measurement set 1 modifies the row in table 610 corresponding with aisle A3, only cells corresponding to other aisles are modified. The cell for aisle A3—and the score values in measurement set 1 corresponding to aisle A3—can be ignored.) Arrows 660 illustrate how scores for each measurement may be summed in the table 610 according to the aisle corresponding to the measurement. (Note: to avoid clutter, arrows have been inserted for only the first three measurements of measurement set 1.) In table 610, the scores for each aisle may be summed and divided over the total number of ESLs for the aisle (thereby normalizing scores based on the number of ESLs in an aisle). (In FIG. 6, N1 represents the total ESLs in aisle A1, N2 represents the total ESLs in aisle A2, and so forth.) This process can be repeated across all measurement sets, where cell values in the table 610 are the sum of the contributions from different measurement sets. As can be seen, a given row in table 610 corresponding to an aisle (e.g., row A3) represents measurement values for which the highest signal strength was measured for the row (and thus, it is likely the measurement set was made while the mobile device was located on a walkway by the aisle), and cell values corresponding to the other aisles (e.g., aisles A1, A2, and A4) will be higher for measurements with higher signal strengths. Rows with cell values above a threshold may be considered to fair a walkway with the given row.

According to some embodiments, aisles are determined to share a walkway if:

$${s}_{i j} \geq c * {s}_{i k} ( j \neq k ) , and {s}_{j i} \geq c * {s}_{j k} ( i \neq k ) , where , c ∈ Z + . \qquad ( Eqn . 1 )$$

Here, sᵢⱼ is a value for a given row i and column j in table 610, sⱼᵢ is a value for a given row j and column i, c is a multiplier (a positive constant; c>0). c is set as 2, for example, an aisle corresponding to a row in table 610 is considered to share a walkway with another aisle, if the value corresponding with the other aisle is at least 2 times greater than other values in the row. Similar principles of survey and evolving the score matrix creation can be used to determine if one aisle shares a walkway with more than one aisle.

Again, the algorithm outlined in FIG. 6 is provided as an example. Alternative embodiments may employ different ways in which aisles with shared walkways may be identified. Alternative embodiments may, for example, use an alternative system by which measurements (e.g., a plurality of measurement sets taken at different locations) corresponding to transceivers in different aisles are scored according to signal strength (and/or another proximity measurement) and pairs of aisles sharing high scores are identified as aisles sharing walkways.

Once a proximity graph has been modified to include shared walkways (and/or back-to-back aisles), it can be used for proximity detection. That is, a mobile device carried by an employee (or robot, customer, etc.) can take measurements of RF signals transmitted by transceivers located at rails and/or ESLs to determine whether the mobile devices within a threshold proximity of a POI corresponding to a particular transceiver. For example, according to some embodiments, the mobile device may be considered to be in proximity to a POI when it measures a certain signal strength from a transceiver corresponding to the POI or any of its immediate neighbors (e.g., transceivers corresponding to vertices in the proximity graph that share an edge with the transceiver corresponding to the POI). For example, a mobile device may be considered to be in proximity to the POI if the mobile device measures at least a threshold signal strength from the transceiver or any of its immediate neighbors, as indicated in the proximity graph.

Further, “closeness,” or distance to a POI, can be determined in terms of edges in a proximity graph. Referring again to FIG. 3, vertex e is three edges away from vertex a. Thus, if the mobile device measures a signal strength above a threshold signal strength from a transceiver corresponding to vertex e (and no other neighbors closer to vertex a), or alternatively, if the strength from the transceiver corresponding to vertex e is the strongest signal measured, the mobile device may be considered three edges away from the transceiver corresponding to vertex a. In this matter, no matter where a mobile device may be within a retail venue, a distance of the mobile device to a POI in terms of edges can be determined using the proximity graph based on the shortest path between the vertex of a transceiver the mobile device is close to, and the vertex corresponding with the POI.

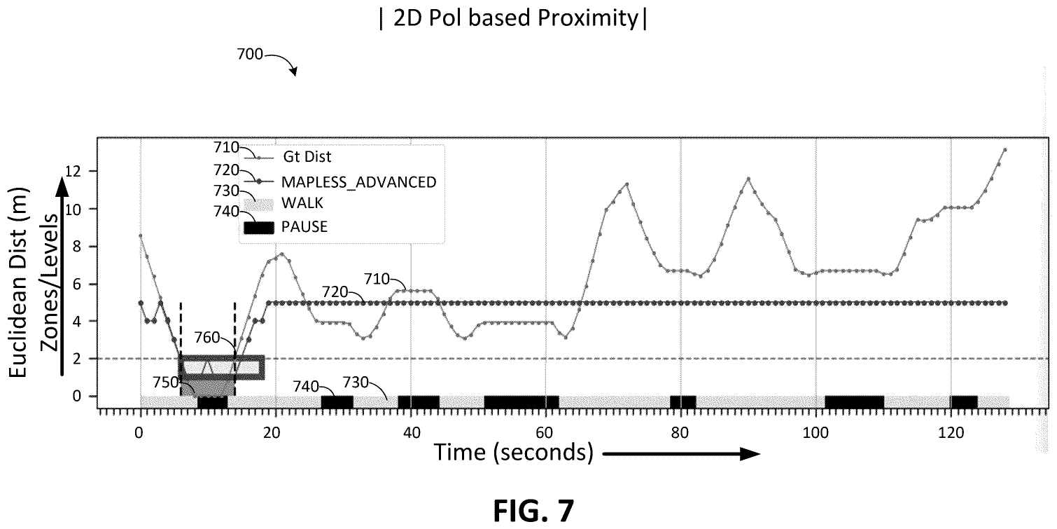

According to some embodiments, zone-based filtering may be employed to help smoothen a proximity trigger. As an example, a given retail venue with a total of five zones representing distance in terms of edges from a POI, such that any vertex within the proximity diagram of the retail venue is between one and five edges from the POI. The zone of the mobile device may be determined based on how many edges are between the vertex corresponding to the transceiver having the strongest signal strength measured by the mobile device and the vertex corresponding to the POI. Proximity may be determined, for example, when the zone of the mobile device is equal to or less than two. Once the mobile device is determined to be proximate to the POI, a determination that the mobile device is no longer proximate to the POI may be made if the zone increases back to five. This type of filtering can help avoid toggling between “proximate” and “not proximate” determinations if measurements cause the mobile device to fluctuate between zones two and three, for example. An example of such filtering is provided in FIG. 7.

FIG. 7 is a graph 700 illustrating actual proximity measurements using the techniques described herein, in an experimental setup. The graph 700 illustrates ground truth distance 710 to a POI measured in terms of meters, as well as a “mapless advanced” proximity 720 (using a proximity graph as described herein) measured in terms of zones. Graph 700 allows for a comparison of the accuracy of the mapless advanced proximity 720 with a ground truth distance of 710. The graph also indicates when the user holding the mobile device with which proximity is determined is walking 730 or paused 740. Graph 700 plots data over a period of approximately 130 seconds. Box 750 illustrates when the mobile device is within a threshold distance, and therefore “proximate,” to the POI (according to ground truth distance 710). And box 760 illustrates when the mobile device is proximate to the POI, in accordance with the mapless advanced proximity 720.

As illustrated by box 760, the mapless advanced proximity 720 provides an accurate reflection of when the mobile device is proximate to a POI. In this experiment, proximity is determined when the mobile device is within two zones (or edges) of the POI. Filtering as described above is also employed such that once proximity is determined, the mobile device is considered no longer proximate to the POI if the mobile device is five zones or greater from the POI. Filtering in this manner is often acceptable because the determination of when a mobile device first becomes proximate to the POI is typically more important than when the mobile device is no longer proximate to the POI. In other words, it is typically important to alert a user (e.g., an employee) when the user arrives at or near a POI, but it is not necessarily important to alert the user when the user leaves the POI. Further test results conducted by the inventors also confirm that the techniques described herein provide proximity detection accuracy and entrance latency (when proximity is determined) at or near levels of map-based positioning proximity detection, with fewer false negatives (e.g., failing to detect the proximity of a POI) than a basic proximity detection using signal strength detection of a single transceiver corresponding to the POI.

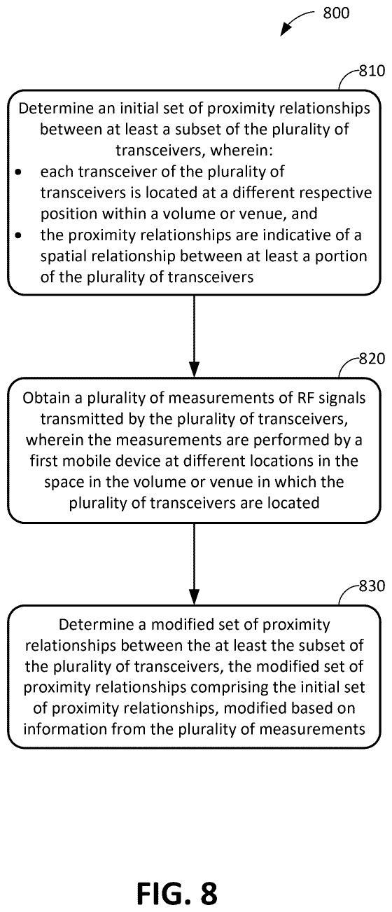

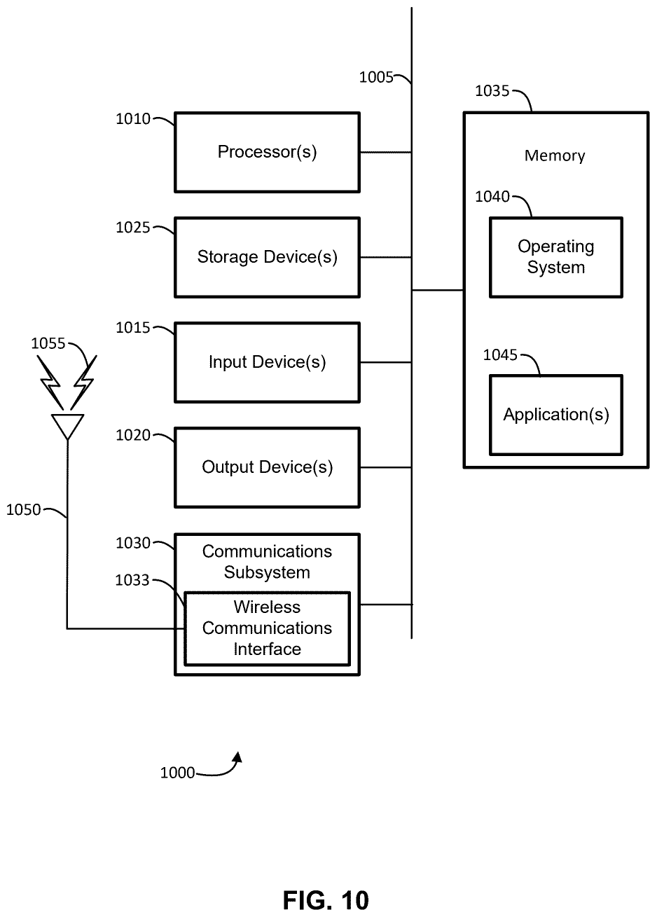

FIG. 8 is a flow diagram of a method 800 of enabling proximity detection among a plurality of transceivers, according to an embodiment. Means and/or structure for performing the functionality illustrated in one or more of the blocks shown in FIG. 8 may be performed by hardware and/or software components of one or more computer systems (e.g., store computer and/or server). Example components of a computer system are illustrated in FIG. 10, which is described in more detail below. That said, some embodiments may perform one or more of the operations illustrated in FIG. 8 using a mobile device (which may be viewed as a mobile computer system).

At block 810, the functionality comprises determining an initial set of proximity relationships between at least a subset of the plurality of transceivers, wherein: each transceiver of the plurality of transceivers is located at a different respective position within a volume or venue, and the proximity relationships are indicative of a spatial relationship between at least a portion of the plurality of transceivers. As described herein, a set of proximity relationships may be represented in a proximity graph, for example. As noted in the embodiments above, determining an initial set of proximity relationships may be based on data indicative of a semantic location of each transceiver of the plurality of transceivers, proximity measurements made by the plurality of transceivers using RF signals, or a combination thereof. As noted herein, data indicative of the semantic location of each transceiver of the plurality of transceivers may comprise tabulated store data (TSD). The proximity measurements made by the plurality of transceivers may comprise Received Signal Strength Indicator (RSSI) measurements.

Means for performing functionality at block 810 may, for example, comprise a bus 1005, one or more processors 1010, one or more storage devices 1025, a memory 1035, an operating system 1040, one or more applications 1045, and/or other components of a computer system 1000, as illustrated in FIG. 10.

The functionality at block 820 comprises obtaining a plurality of measurements of RF signals transmitted by the plurality of transceivers, wherein the measurements are performed by a first mobile device at different locations in the space in the volume or venue in which the plurality of transceivers are located. This functionality may correspond with the performance of the device-based survey is described in the embodiments herein. As noted herein, the measurements may be obtained, for example, by a mobile device (or multiple mobile devices), that take measurements of transceivers at the different locations in the volume or venue in which the plurality of transceivers are located. As previously described, this may mean taking measurements along a guided route and/or taking measurements opportunistically as the mobile device(s) moves throughout volume or venue as during the ordinary course of business.

Means for performing functionality at block 830 may, for example, comprise a bus 1005, one or more processors 1010, one or more storage devices 1025, one or more input devices 1015, a communications subsystem 1030, a memory 1035, an operating system 1040, one or more applications 1045, and/or other components of a computer system 1000, as illustrated in FIG. 10.

The functionality at block 830 comprises determining a modified set of proximity relationships between the at least the subset of the plurality of transceivers, the modified set of proximity relationships comprising the initial set of proximity relationships, modified based on information from the plurality of measurements. As noted herein, this modification may reflect additional information obtained from the plurality of measurements. This can include, for example, information regarding aisles the share walkways and/or aisles that are back-to-back.

For example, according to some embodiments, the volume or venue may comprise a retail environment. In such embodiments, each transceiver of the plurality of transceivers may correspond with an ESL, a rail, or a combination thereof. Additionally or alternatively, determining the modified set of proximity relationships between the at least the subset of the plurality of transceivers may comprise determining a shared walkway between aisles in the retail environment. In such embodiments, determining the shared walkway between aisles may comprise scoring measurements of the plurality of measurements according to signal strength and identifying pairs of aisles sharing high scores. An example of this is illustrated in FIG. 6, and described above.

Means for performing functionality at block 830 may, for example, comprise a bus 1005, one or more processors 1010, one or more storage devices 1025, a memory 1035, an operating system 1040, one or more applications 1045, and/or other components of a computer system 1000, as illustrated in FIG. 10.

This information may be used, for example, for proximity detection as described herein. For example, some embodiments may further comprise using the modified set of proximity relationships to determine a proximity of a second mobile device to a POI. In such embodiments, using the modified set of proximity relationships to determine the proximity of a second mobile device to the POI may comprise measuring a signal strength of one or more transceivers of the plurality of transceivers; determining a nearest transceiver to the second mobile device based on the signal strength of the one or more transceivers; and determining the proximity of a second mobile device to the POI based on a proximity of the nearest transceiver to a transceiver corresponding to the POI. Additionally, or alternatively, the modified set of proximity relationships may comprise a proximity graph in which proximity relationships between the at least the subset of the plurality of transceivers are represented by edges between vertices corresponding to the at least the subset of the plurality of transceivers. Such embodiments may further comprise determining the second mobile device to be proximate to the POI when a number of edges between a vertex corresponding to the nearest transceiver and a vertex corresponding to a transceiver of the POI is below a threshold number of edges. Additionally, or alternatively, the initial set of proximity relationships, the modified set of proximity relationships, or both include one or more weights indicative of how proximate at least two transceivers of the plurality of transceivers are to one another.

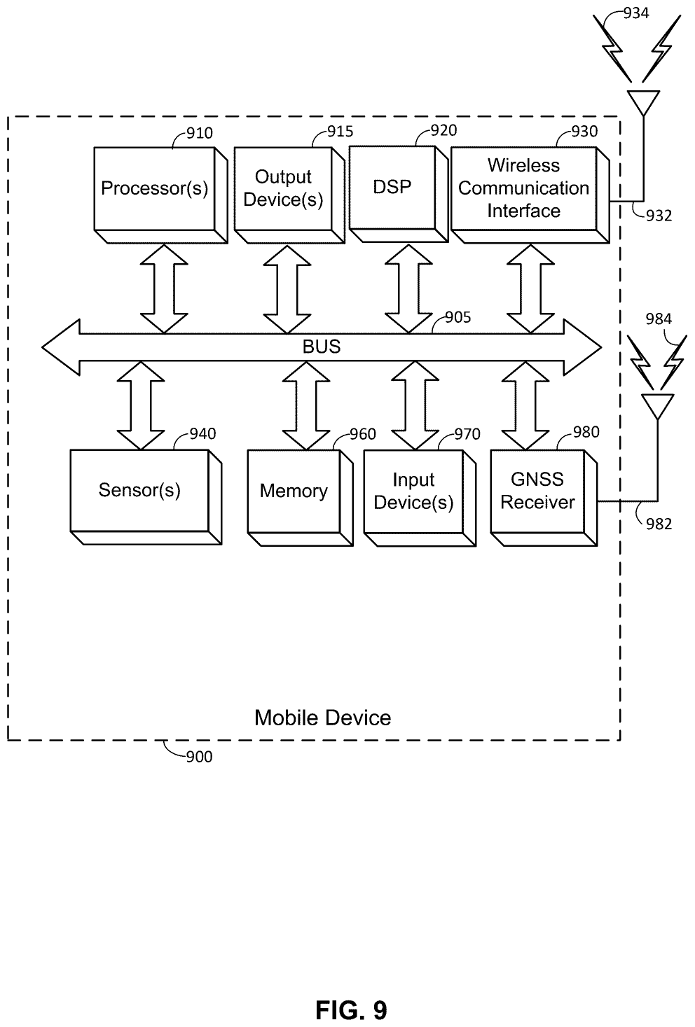

FIG. 9 is a block diagram of an embodiment of a mobile device 900, which can be utilized as described herein (e.g., in association with the previously described figures). The mobile device can be used, for example, to perform measurements of transceivers as described herein for purposes of determining a modified proximity graph and/or performing proximity detection using a proximity graph. It should be noted that FIG. 9 is meant only to provide a generalized illustration of various components, any or all of which may be utilized as appropriate. Furthermore, the functionality of the UE discussed herein may be executed by one or more of the hardware and/or software components illustrated in FIG. 9.

The mobile device 900 is shown comprising hardware elements that can be electrically coupled via a bus 905 (or may otherwise be in communication, as appropriate). The hardware elements may include a processor(s) 910, which can include without limitation one or more general-purpose processors (e.g., an application processor), one or more special-purpose processors (such as DSP chips, graphics acceleration processors, application-specific integrated circuits (ASICs), and/or the like), and/or other processing structures or means. Processor(s) 910 may comprise one or more processing units, which may be housed in a single integrated circuit (IC) or multiple ICs. As shown in FIG. 9, some embodiments may have a separate DSP 920, depending on the desired functionality. Location determination and/or other determinations based on wireless communication may be provided in the processor(s) 910 and/or wireless communication interface 930 (discussed below). The mobile device 900 also can include one or more input devices 970, which can include without limitation one or more keyboards, touch screens, touch pads, microphones, buttons, dials, switches, and/or the like; and one or more output devices 915, which can include without limitation one or more displays (e.g., touch screens), light emitting diodes (LEDs), speakers, and/or the like.

The mobile device 900 may also include a wireless communication interface 930, which may comprise without limitation a modem, a network card, an infrared communication device, a wireless communication device, and/or a chipset (such as a Bluetooth® device (including BLE), an IEEE 802.11 device, an IEEE 802.15.4 device, a Wi-Fi device, a WiMAX device, a WAN device, and/or various cellular devices, etc.), and/or the like, which may enable the mobile device 900 to communicate with other devices (e.g., a store computer, a cloud service, etc.) and/or perform measurements of transceivers as described in the embodiments above. The wireless communication interface 930 may permit data and signaling to be communicated (e.g., transmitted and received) with communication networks (cellular, Wi-Fi, etc.) via access points, base stations, and/or other access node types, and/or other network components, computer systems, and/or any other electronic devices communicatively coupled with the communication network. The communication can be carried out via one or more wireless communication antenna(s) 932 that send and/or receive wireless signals 934. According to some embodiments, the wireless communication antenna(s) 932 may comprise a plurality of discrete antennas, antenna arrays, or any combination thereof. The antenna(s) 932 may be capable of transmitting and receiving wireless signals using beams (e.g., Tx beams and Rx beams). Beam formation may be performed using digital and/or analog beam formation techniques with respective digital and/or analog circuitry. The wireless communication interface 930 may include such circuitry.

Depending on desired functionality, the wireless communication interface 930 may comprise a separate receiver and transmitter or any combination of transceivers, transmitters, and/or receivers to communicate with base stations and other terrestrial transceivers, such as wireless devices and access points. The mobile device 900 may communicate with different data networks that may comprise various network types. For example, one such network type may comprise a wireless wide area network (WWAN), which may be a code-division multiple access (CDMA) network, a time division multiple access (TDMA) network, a frequency division multiple access (FDMA) network, an orthogonal frequency division multiple access (OFDMA) network, a single-carrier frequency division multiple access (SC-FDMA) network, a WiMAX (IEEE 802.16) network, and so on. A CDMA network may implement one or more radio access technologies (RATs) such as CDMA2000®, wideband code division multiple access (WCDMA), and so on. CDMA2000® includes IS-95, IS-2000 and/or IS-856 standards. A TDMA network may implement global system for mobile communications (GSM), digital advanced mobile phone system (D-AMPS), or some other RAT. An OFDMA network may employ long-term evolution (LTE), LTE Advanced, fifth-generation (5G) new radio (NR), and so on. 5G NR, LTE, LTE Advanced, GSM, and WCDMA are described in documents from 3rd Generation Partnership Project (3GPP). CDMA2000® is described in documents from a consortium named “3rd Generation Partnership Project 2” (3GPP2). 3GPP and 3GPP2 documents are publicly available. A wireless local area network (WLAN) may also be an IEEE 802.11x network, and a wireless personal area network (WPAN) may be a Bluetooth network, an IEEE 802.15x, or some other type of network. The techniques described herein may also be used for any combination of WWAN, WLAN and/or WPAN.

The mobile device 900 can further include sensor(s) 940. Sensor(s) 940 may comprise, without limitation, one or more inertial sensors and/or other sensors (e.g., accelerometer(s), gyroscope(s), camera(s), magnetometer(s), altimeter(s), microphone(s), proximity sensor(s), light sensor(s), barometer(s), and the like), some of which may be used to obtain position-related measurements and/or other information.

Embodiments of the mobile device 900 may also include a Global Navigation Satellite System (GNSS) receiver 980 capable of receiving signals 984 from one or more GNSS satellites using an antenna 982 (which could be the same as antenna 932). Positioning based on GNSS signal measurement can be utilized to complement and/or incorporate the techniques described herein. The GNSS receiver 980 can extract a position of the mobile device 900, using conventional techniques, from GNSS satellites of a GNSS system, such as Global Positioning System (GPS), Galileo, GLONASS, Quasi-Zenith Satellite System (QZSS) over Japan, IRNSS over India, BeiDou Navigation Satellite System (BDS) over China, and/or the like. Moreover, the GNSS receiver 980 can be used with various augmentation systems (e.g., a Satellite Based Augmentation System (SBAS)) that may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

It can be noted that, although GNSS receiver 980 is illustrated in FIG. 9 as a distinct component, embodiments are not so limited. As used herein, the term “GNSS receiver” may comprise hardware and/or software components configured to obtain GNSS measurements (measurements from GNSS satellites). In some embodiments, therefore, the GNSS receiver may comprise a measurement engine executed (as software) by one or more processors, such as processor(s) 910, DSP 920, and/or a processor within the wireless communication interface 930 (e.g., in a modem). A GNSS receiver may optionally also include a positioning engine, which can use GNSS measurements from the measurement engine to determine a position of the GNSS receiver using an Extended Kalman Filter (EKF), Weighted Least Squares (WLS), a hatch filter, particle filter, or the like. The positioning engine may also be executed by one or more processors, such as processor(s) 910 or DSP 920.

The mobile device 900 may further include and/or be in communication with a memory 960. The memory 960 can include, without limitation, local and/or network accessible storage, a disk drive, a drive array, an optical storage device, a solid-state storage device, such as a random access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 960 of the mobile device 900 also can comprise software elements (not shown in FIG. 9), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 960 that are executable by the mobile device 900 (and/or processor(s) 910 or DSP 920 within mobile device 900). In some embodiments, then, such code and/or instructions can be used to configure and/or adapt a general-purpose computer (or other device) to perform one or more operations in accordance with the described methods.

FIG. 10 is a block diagram of an embodiment of a computer system 1000, which may be used, in whole or in part, to provide the functions of one or more components, servers, and/or devices as described in the embodiments herein (e.g., a store computer and/or cloud server). This may include, for example, a computer server, personal computer, personal electronic device, or the like. It should be noted that FIG. 10 is meant only to provide a generalized illustration of various components, any or all of which may be utilized as appropriate. FIG. 10, therefore, broadly illustrates how individual system elements may be implemented in a relatively separated or relatively more integrated manner. In addition, it can be noted that components illustrated by FIG. 10 can be localized to a single device and/or distributed among various networked devices, which may be disposed at different geographical locations.

The computer system 1000 is shown comprising hardware elements that can be electrically coupled via a bus 1005 (or may otherwise be in communication, as appropriate). The hardware elements may include processor(s) 1010, which may comprise without limitation one or more general-purpose processors, one or more special-purpose processors (such as digital signal processing chips, graphics acceleration processors, and/or the like), and/or other processing structure, which can be configured to perform one or more of the methods described herein. The computer system 1000 also may comprise one or more input devices 1015, which may comprise without limitation a mouse, a keyboard, a camera, a microphone, and/or the like; and one or more output devices 1020, which may comprise without limitation a display device, a printer, and/or the like.

The computer system 1000 may further include (and/or be in communication with) one or more non-transitory storage devices 1025, which can comprise, without limitation, local and/or network accessible storage, and/or may comprise, without limitation, a disk drive, a drive array, an optical storage device, a solid-state storage device, such as a random-access memory (RAM) and/or read-only memory (ROM), which can be programmable, flash-updateable, and/or the like. Such storage devices may be configured to implement any appropriate data stores, including without limitation, various file systems, database structures, and/or the like. Such data stores may include database(s) and/or other data structures used store and administer messages and/or other information to be sent to one or more devices via hubs, as described herein.

The computer system 1000 may also include a communications subsystem 1030, which may comprise wireless communication technologies managed and controlled by a wireless communication interface 1033, as well as wired technologies (such as Ethernet, coaxial communications, universal serial bus (USB), and the like). The wireless communication interface 1033 may comprise one or more wireless transceivers that may send and receive wireless signals 1055 (e.g., signals according to 5G NR or LTE) via wireless antenna(s) 1050. Thus the communications subsystem 1030 may comprise a modem, a network card (wireless or wired), an infrared communication device, a wireless communication device, and/or a chipset, and/or the like, which may enable the computer system 1000 to communicate on any or all of the communication networks described herein to any device on the respective network, including a User Equipment (UE), base stations and/or other transmission reception points (TRPs), and/or any other electronic devices described herein. Hence, the communications subsystem 1030 may be used to receive and send data as described in the embodiments herein.

In many embodiments, the computer system 1000 will further comprise a working memory 1035, which may comprise a RAM or ROM device, as described above. Software elements, shown as being located within the working memory 1035, may comprise an operating system 1040, device drivers, executable libraries, and/or other code, such as one or more applications 1045, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the storage device(s) 1025 described above. In some cases, the storage medium might be incorporated within a computer system, such as computer system 1000. In other embodiments, the storage medium might be separate from a computer system (e.g., a removable medium, such as an optical disc), and/or provided in an installation package, such that the storage medium can be used to program, configure, and/or adapt a general purpose computer with the instructions/code stored thereon. These instructions might take the form of executable code, which is executable by the computer system 1000 and/or might take the form of source and/or installable code, which, upon compilation and/or installation on the computer system 1000 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used and/or particular elements might be implemented in hardware, software (including portable software, such as applets, etc.), or both. Further, connection to other computing devices such as network input/output devices may be employed.

Also, it can be noted that terms such as “N” and “M” are used in the description and in the figures to represent some number (e.g., an integer value). However, the reuse of the term in different contexts does not necessarily mean the value is the same in each of those contexts. That is, the value N may be used in two different contexts (even within the same figure), in which case the value may be different in each context.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processors and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description embodiments may include different combinations of features. Implementation examples are described in the following numbered clauses:

Clause 1: A method of enabling proximity detection among a plurality of transceivers, the method comprising: determining an initial set of proximity relationships between at least a subset of the plurality of transceivers, wherein: each transceiver of the plurality of transceivers is located at a different respective position within a volume or venue, and the proximity relationships are indicative of a spatial relationship between at least a portion of the plurality of transceivers; obtaining a plurality of measurements of radio frequency (RF) signals transmitted by the plurality of transceivers, wherein the measurements are performed by a first mobile device at different locations in the volume or venue in which the plurality of transceivers are located; and determining a modified set of proximity relationships between the at least the subset of the plurality of transceivers, the modified set of proximity relationships comprising the initial set of proximity relationships, modified based on information from the plurality of measurements.

Clause 2: The method of clause 1, wherein determining the initial set of proximity relationships is based on: data indicative of a semantic location of each transceiver of the plurality of transceivers, proximity measurements made by the plurality of transceivers using RF signals, or a combination thereof.

Clause 3: The method of either of clauses 1 or 2, wherein the data indicative of the semantic location of each transceiver of the plurality of transceivers comprises tabulated store data (TSD).

Clause 4: The method of any one of clauses 2-3, wherein the proximity measurements made by the plurality of transceivers comprise Received Signal Strength Indicator (RSSI) measurements.

Clause 5: The method of any one of clauses 1-4, further comprising using the modified set of proximity relationships to determine a proximity of a second mobile device to a point of interest (POI).

Clause 6: The method of clause 5, wherein using the modified set of proximity relationships to determine the proximity of a second mobile device to the POI comprises: measuring a signal strength of one or more transceivers of the plurality of transceivers; determining a nearest transceiver of the one or more transceivers to the second mobile device based on the signal strength of the one or more transceivers; and determining the proximity of a second mobile device to the POI based on a proximity of the nearest transceiver to a transceiver corresponding to the POI.

Clause 7: The method of clause 6, wherein the modified set of proximity relationships comprises a proximity graph in which proximity relationships between the at least the subset of the plurality of transceivers are represented by edges between vertices corresponding to the at least the subset of the plurality of transceivers, and wherein the method further comprises determining the second mobile device to be proximate to the POI when a number of edges between a vertex corresponding to the nearest transceiver and a vertex corresponding to a transceiver of the POI is below a threshold number of edges.

Clause 8: The method of any one of clauses 1-7, wherein the volume or venue comprises a retail environment.

Clause 9: The method of clause 8, wherein each transceiver of the plurality of transceivers corresponds with an electric store label (ESL), a rail, or a combination thereof.

Clause 10: The method of any one of clauses 8-9, wherein determining the modified set of proximity relationships between the at least the subset of the plurality of transceivers comprises determining a shared walkway between aisles in the retail environment.

Clause 11: The method of clause 10, wherein determining the shared walkway between aisles comprises scoring measurements of the plurality of measurements according to signal strength and identifying pairs of aisles sharing high scores.

Clause 12: The method of any one of clauses 1-13, wherein the initial set of proximity relationships, the modified set of proximity relationships, or both include one or more weights indicative of how proximate at least two transceivers of the plurality of transceivers are to one another.

Clause 13: A computer system for enabling proximity detection among a plurality of transceivers, the computer system comprising: at least one communication interface; at least one memory; and at least one processor communicatively coupled with the at least one communication interface and at least one memory, the at least one processor configured to: determine an initial set of proximity relationships between at least a subset of the plurality of transceivers, wherein: each transceiver of the plurality of transceivers is located at a different respective position within a volume or venue, and the proximity relationships are indicative of a spatial relationship between at least a portion of the plurality of transceivers; obtain, via the at least one communication interface, a plurality of measurements of radio frequency (RF) signals transmitted by the plurality of transceivers, wherein the measurements are performed by a first mobile device at different locations in the volume or venue in which the plurality of transceivers are located; and determine a modified set of proximity relationships between the at least the subset of the plurality of transceivers, the modified set of proximity relationships comprising the initial set of proximity relationships, modified based on information from the plurality of measurements.

Clause 14: The computer system of clause 13, wherein the at least one processor is configured to determine the initial set of proximity relationships is based on: data indicative of a semantic location of each transceiver of the plurality of transceivers; proximity measurements made by the plurality of transceivers using RF signals, or; and a combination thereof.

Clause 15: The computer system of either of clauses 13 or 14, wherein the data indicative of the semantic location of each transceiver of the plurality of transceivers comprises tabulated store data (TSD).

Clause 16: The computer system of any one of clauses 14-15, wherein the proximity measurements made by the plurality of transceivers comprise Received Signal Strength Indicator (RSSI) measurements.

Clause 17: The computer system of any one of clauses 13-16, wherein the at least one processor is further configured to use the modified set of proximity relationships to determine a proximity of a second mobile device to a point of interest (POI).

Clause 18: The computer system of clause 17, wherein, to use the modified set of proximity relationships to determine the proximity of a second mobile device to the POI, the at least one processor is configured to: measure a signal strength of one or more transceivers of the plurality of transceivers; determine a nearest transceiver of the one or more transceivers to the second mobile device based on the signal strength of the one or more transceivers; and determine the proximity of a second mobile device to the POI based on a proximity of the nearest transceiver to a transceiver corresponding to the POI.

Clause 19: The computer system of clause 18, wherein the modified set of proximity relationships comprises a proximity graph in which proximity relationships between the at least the subset of the plurality of transceivers are represented by edges between vertices corresponding to the at least the subset of the plurality of transceivers, and wherein the at least one processor is further configured to determine the second mobile device to be proximate to the POI when a number of edges between a vertex corresponding to the nearest transceiver and a vertex corresponding to a transceiver of the POI is below a threshold number of edges.

Clause 20: The computer system of any one of clauses 13-19, wherein the volume or venue comprises a retail environment.

Clause 21: The computer system of clause 20, wherein each transceiver of the plurality of transceivers corresponds with an electric store label (ESL), a rail, or a combination thereof.

Clause 22: The computer system of any one of clauses 13-21, wherein, to determine the modified set of proximity relationships between the at least the subset of the plurality of transceivers, the at least one processor is configured to determine a shared walkway between aisles in the retail environment.

Clause 23: The computer system of clause 22, wherein, to determine the shared walkway between aisles, the at least one processor is configured to score measurements of the plurality of measurements according to signal strength and identifying pairs of aisles sharing high scores.

Clause 24: The computer system of any one of clauses 13-23, wherein the initial set of proximity relationships, the modified set of proximity relationships, or both include one or more weights indicative of how proximate at least two transceivers of the plurality of transceivers are to one another.

Clause 14: An apparatus having means for performing the method of any one of clauses 1-12.

Clause 15: A non-transitory computer-readable medium storing instructions, the instructions comprising code for performing the method of any one of clauses 1-12.

What is claimed is:

1. A method of enabling proximity detection among a plurality of transceivers, the method comprising:
determining an initial set of proximity relationships between at least a subset of the plurality of transceivers, wherein:
each transceiver of the plurality of transceivers is located at a different respective position within a volume or venue, and
the proximity relationships are indicative of a spatial relationship between at least a portion of the plurality of transceivers;
obtaining a plurality of measurements of radio frequency (RF) signals transmitted by the plurality of transceivers, wherein the measurements are performed by a first mobile device at different locations in the volume or venue in which the plurality of transceivers are located; and
determining a modified set of proximity relationships between the at least the subset of the plurality of transceivers, the modified set of proximity relationships comprising the initial set of proximity relationships, modified based on information from the plurality of measurements.

2. The method of claim 1, wherein determining the initial set of proximity relationships is based on:
data indicative of a semantic location of each transceiver of the plurality of transceivers,
proximity measurements made by the plurality of transceivers using RF signals, or
a combination thereof.

3. The method of claim 2, wherein the data indicative of the semantic location of each transceiver of the plurality of transceivers comprises tabulated store data (TSD).

4. The method of claim 2, wherein the proximity measurements made by the plurality of transceivers comprise Received Signal Strength Indicator (RSSI) measurements.

5. The method of claim 1, further comprising using the modified set of proximity relationships to determine a proximity of a second mobile device to a point of interest (POI).

6. The method of claim 5, wherein using the modified set of proximity relationships to determine the proximity of a second mobile device to the POI comprises:
measuring a signal strength of one or more transceivers of the plurality of transceivers;
determining a nearest transceiver of the one or more transceivers to the second mobile device based on the signal strength of the one or more transceivers; and
determining the proximity of a second mobile device to the POI based on a proximity of the nearest transceiver to a transceiver corresponding to the POI.

7. The method of claim 6, wherein the modified set of proximity relationships comprises a proximity graph in which proximity relationships between the at least the subset of the plurality of transceivers are represented by edges between vertices corresponding to the at least the subset of the plurality of transceivers, and wherein the method further comprises determining the second mobile device to be proximate to the POI when a number of edges between a vertex corresponding to the nearest transceiver and a vertex corresponding to a transceiver of the POI is below a threshold number of edges.

8. The method of claim 1, wherein the volume or venue comprises a retail environment.

9. The method of claim 8, wherein each transceiver of the plurality of transceivers corresponds with an electric store label (ESL), a rail, or a combination thereof.

10. The method of claim 8, wherein determining the modified set of proximity relationships between the at least the subset of the plurality of transceivers comprises determining a shared walkway between aisles in the retail environment.

11. The method of claim 10, wherein determining the shared walkway between aisles comprises scoring measurements of the plurality of measurements according to signal strength and identifying pairs of aisles sharing high scores.

12. The method of claim 1, wherein the initial set of proximity relationships, the modified set of proximity relationships, or both include one or more weights indicative of how proximate at least two transceivers of the plurality of transceivers are to one another.

13. A computer system for enabling proximity detection among a plurality of transceivers, the computer system comprising:
at least one communication interface;
at least one memory; and
at least one processor communicatively coupled with the at least one communication interface and at least one memory, the at least one processor configured to:
determine an initial set of proximity relationships between at least a subset of the plurality of transceivers, wherein:
each transceiver of the plurality of transceivers is located at a different respective position within a volume or venue, and
the proximity relationships are indicative of a spatial relationship between at least a portion of the plurality of transceivers;
obtain, via the at least one communication interface, a plurality of measurements of radio frequency (RF) signals transmitted by the plurality of transceivers, wherein the measurements are performed by a first mobile device at different locations in the volume or venue in which the plurality of transceivers are located; and
determine a modified set of proximity relationships between the at least the subset of the plurality of transceivers, the modified set of proximity relationships comprising the initial set of proximity relationships, modified based on information from the plurality of measurements.

14. The computer system of claim 13, wherein the at least one processor is configured to determine the initial set of proximity relationships is based on:
data indicative of a semantic location of each transceiver of the plurality of transceivers;
proximity measurements made by the plurality of transceivers using RF signals, or; and
a combination thereof.

15. The computer system of claim 14, wherein the data indicative of the semantic location of each transceiver of the plurality of transceivers comprises tabulated store data (TSD).

16. The computer system of claim 14, wherein the proximity measurements made by the plurality of transceivers comprise Received Signal Strength Indicator (RSSI) measurements.

17. The computer system of claim 13, wherein the at least one processor is further configured to use the modified set of proximity relationships to determine a proximity of a second mobile device to a point of interest (POI).

18. The computer system of claim 17, wherein, to use the modified set of proximity relationships to determine the proximity of a second mobile device to the POI, the at least one processor is configured to:
measure a signal strength of one or more transceivers of the plurality of transceivers;
determine a nearest transceiver of the one or more transceivers to the second mobile device based on the signal strength of the one or more transceivers; and
determine the proximity of a second mobile device to the POI based on a proximity of the nearest transceiver to a transceiver corresponding to the POI.

19. The computer system of claim 18, wherein the modified set of proximity relationships comprises a proximity graph in which proximity relationships between the at least the subset of the plurality of transceivers are represented by edges between vertices corresponding to the at least the subset of the plurality of transceivers, and wherein the at least one processor is further configured to determine the second mobile device to be proximate to the POI when a number of edges between a vertex corresponding to the nearest transceiver and a vertex corresponding to a transceiver of the POI is below a threshold number of edges.

20. An device for enabling proximity detection among a plurality of transceivers, the device comprising:
means for determining an initial set of proximity relationships between at least a subset of the plurality of transceivers, wherein:
each transceiver of the plurality of transceivers is located at a different respective position within a volume or venue, and
the proximity relationships are indicative of a spatial relationship between at least a portion of the plurality of transceivers;
means for obtaining a plurality of measurements of radio frequency (RF) signals transmitted by the plurality of transceivers, wherein the measurements are performed by a first mobile device at different locations in the volume or venue in which the plurality of transceivers are located; and
means for determining a modified set of proximity relationships between the at least the subset of the plurality of transceivers, the modified set of proximity relationships comprising the initial set of proximity relationships, modified based on information from the plurality of measurements.
